(19) United States
(12) Patent Application Publication
(10) Pub. No.: US 2009/0006303 A1
(43) Pub. Date: Jan. 1, 2009

(54) Knowledge Auction System and Method

(76) Inventor: Dongman Shin, Gyeonggi-do (KR)

Correspondence Address: LEXYOUME IP GROUP, LLC, 5180 PARKSTONE DRIVE, SUITE 175, CHANTILLY, VA, 20151, US

(21) Appl. No.: 12/159,317

(22) PCT Filed: Feb. 12, 2007
(86) PCT No.: PCT/KR2007/000751

§ 371 Date: Jun. 26, 2008

(30) Foreign Application Priority Data
Feb. 13, 2006 (KR) 10-2006-0013617

(51) Int. Cl. G06N 5/02

(52) U.S. Cl. 706/50

(57) ABSTRACT

The present invention relates to a knowledge auction system and method, in which points provided in return for one or more answers are provided in an auction fashion in a knowledge trading system in which a plurality of answerers provides answers to a question registered by a questioner and the questioner selects one or more desired answers, so that high-quality answers can be elicited, and thus knowledge trading can be promoted. According to the knowledge auction system and method according to the present invention, knowledge trading through questions and answers between the questioner clients and the answerer clients is performed through auctions, so that the price for knowledge can be reasonably determined depending on the uniqueness, difficulty and quality of knowledge, with the result that knowledge trading can be promoted, and the uniqueness and quality of provided knowledge can be significantly improved.

### TECHNICAL FIELD

The present invention relates to a knowledge auction system and method and, more particularly, to a knowledge auction system and method, in which points provided in return for one or more answers are provided in an auction fashion in a knowledge trading system in which a plurality of answerers provides answers to a question registered by a questioner and the questioner selects one or more desired answers, so that high-quality answers can be elicited, and thus knowledge trading can be promoted.

### BACKGROUND ART

Conventionally, in order to obtain information from the Internet, a method of searching for relevant websites or web pages by inputting a search keyword into a search engine and surfing related sites has been used. In this case, related sites must be visited one by one in order to obtain information, so that there are problems in that a lot of time and effort is required, obtained information varies greatly depending on a user's search ability, and it is difficult to obtain accurate information desired by the user.

Accordingly, in order to enable a user to obtain necessary information easily and rapidly, knowledge trading services, in which other users provide answers to a question when a user registers the question, have been proposed. The knowledge trading service motivates answerers and promotes answers in such a way that a questioner selects a desired one from among several answers and a system or the questioner provides some knowledge points to the answerer who provides the selected answer. For knowledge points provided in this case, specific points may be basically set in a knowledge trading system, and a questioner may award additional points when necessary. However, in the case of a conventional knowledge trading service, a small number of knowledge points are provided, the use of the knowledge points is limited, and thus most knowledge is exchanged simply to satisfy curiosity. Furthermore, since answerers, who are amateurs rather than experts, post information obtained through the Internet, etc. or personal opinions as answers, the quality of the answers is not high. Therefore, there is a problem in that it is difficult for a questioner to select a desired one from among the provided answers because professional and high-quality knowledge is not provided.

Meanwhile, with the popularization of Internet advertisements, Internet advertising services in which products, etc. are advertised in various websites and fees are charged, are provided in various ways. Conventional Internet advertising services include 1) banner advertisement, in which banners, such as advertising messages, are displayed at specific locations of web pages, and billing is made based on the number of exposures of the banners or the number of clicks on the banners, 2) insertion-type advertisement, in which, when a web page is loaded into a user terminal, advertising data is transmitted to and displayed on a user's terminal, and billing is made based on the number of transmissions of advertising data, 3) keyword advertisement, in which, when a user inputs a keyword for searching, the website of an advertiser is placed over a search result list, and billing is made based on the number of exposures of search results, the number of times that users have accessed the website, or the like. However, banner advertisement is problematic in that it is difficult to achieve a desired advertising effect because it does not attract users' interest and because the rate of access to a website through a banner is very low. The insertion-type advertisement is problematic in that exposure to advertisements is involuntary, and users' antipathy results because the loading of a web page is delayed until the transmission of advertising data is completed. In a similar way, since the fact that websites are placed at the top of search lists for the purpose of advertisement is known to general users, keyword advertisement has a low rate of encouraging access to a website, and has a low advertising effect because users avoid accessing corresponding websites because they avoid advertisements. Accordingly, there is a need for an Internet advertising method capable of making effective advertisements without causing users' antipathy.

### DISCLOSURE OF INVENTION

### Technical Problem

Accordingly, the present invention has been made keeping in mind the above problems occurring in the prior art, and an object of the present invention is to provide a knowledge auction system and method, in which questioner clients register points to be provided to one or more answerer clients, along with questions, and answerer clients also register points to be provided along with answers, so that knowledge trading is promoted in an auction fashion and the registration of professional and high-quality answers is encouraged.

Another object of the present invention is to provide a knowledge auction system and method, in which advertiser clients register answers, including advertising information, while providing some advertising payments in return for the questions of questioner clients, provide advertising information and links to the websites of advertisers when general members search knowledge, and provide advertising payments to users who access the websites of the advertisers, so that the rates of access to the websites of the advertisers increase, thereby increasing advertising effects.

A further object of the present invention is to provide a knowledge auction system and method, in which knowledge evaluation is performed on registered knowledge information, so that the trading prices of knowledge information can be reasonably and objectively set and high-quality knowledge information can be provided.

### Technical Solution

In order to accomplish the above objects, the present invention provides a knowledge trading system for intermediating knowledge trading between questioner clients for registering question information and answerer clients for registering answer information for the question information, registering traded knowledge, and providing knowledge information, including the question information and the answer information, to viewer clients for searching and viewing the knowledge, the knowledge trading system including a knowledge processing unit, including a question processing module for receiving and registering question information, including question content and provided points, to be provided to one or more answerer clients that input selected answers, from one of the questioner clients, and providing the question information to each of the answerer clients, an answer processing module for receiving and registering answer information, including answer content and additional points, additionally requested to be provided along with the provided points when the answer information is selected, from one or more of the answerer clients, and providing the answer information to the questioner client, and a point provision module for providing the sum of the provided points and the additional points to the answerer clients that input the answer information selected by the questioner client, as knowledge points, receiving percentages of knowledge points, to be provided to the respective answer clients that input the selected answer information, from the questioner client when the questioner client selects multiple pieces of answer information, and providing each of the one or more answerer clients with knowledge points based on the input percentages; a knowledge registration unit for generating knowledge information by combining the question information and the selected answer information, and registering the generated knowledge information; a knowledge provision unit for charging the knowledge points to each viewer client that requests the knowledge information, and providing the knowledge information to the viewer client; and a knowledge database for storing the question information, the answer information, and the knowledge information.

Preferably, the question information includes a question identification code for identifying the question information, a questioner identification code for identifying the questioner client, a category for indicating a class of the question information, a question title, the question content, the provided points, and an answer period, that is, a period during which the answerer clients can input answer information; and the answer information includes an answer identification code for identifying the answer information, a question identification code for identifying the question information, an answerer identification code for identifying the answerer client, the answer content, and the additional points.

Preferably, the knowledge information includes a knowledge identification code for identifying the knowledge information, a questioner identification code for identifying the questioner client, an answerer identification code for identifying the answerer client, a category for indicating a class of the question information, a question title, the question content, the answer content, and the knowledge points.

Preferably, the question information further includes a value, indicating whether the registered answer information is a secret question, which is not generated as the knowledge information by the knowledge registration unit and is provided only to the questioner client; and the answer information further includes a value, indicating whether the registered answer information is a secret answer, which is excluded from the knowledge information generated by the knowledge registration unit and is provided only to the questioner client, and a lower limit number of the knowledge points, to be provided when the questioner client selects the answer information.

Preferably, the knowledge trading system further includes a knowledge evaluation unit for receiving evaluation content for the answer information of the generated knowledge information and new knowledge points for the generated knowledge information from each viewer client during a set evaluation period, and performing knowledge evaluation, in which the knowledge points are reset for the knowledge information. The knowledge evaluation unit register the input evaluation content in the knowledge information, and the knowledge points may be set to the average of the existing knowledge points and the new knowledge points.

The present invention provides a knowledge auction method of intermediating knowledge trading between questioner clients for registering question information and answerer clients for registering answer information for the question information, registering traded knowledge, and providing knowledge information, including the question information and the answer information, to viewer clients for searching and viewing the knowledge, the knowledge auction method including: step 1 of receiving question information, including question content and provided points, to be provided to one or more answerer clients that input selected answers, from each of the questioner clients; step 2 of storing the question information, and providing the question information to each of the answerer clients; step 3 of receiving answer information, including answer content and additional points, additionally requested to be provided along with the provided points when the answer information is selected, from one or more of the answerer clients; step 4 of storing the answer information, and providing part of the answer content and information about the additional points to the questioner client; step 5 of allowing the questioner client to select one or more pieces of the answer information from the answer information; step 6 of providing the sum of the provided points and the additional points to the answerer clients that input the answer information selected by the questioner client, as knowledge points; step 7 of generating knowledge information by combining the question information and the selected answer information, and storing the generated knowledge information; step 8 of receiving a request for provision of the knowledge information from one or more viewer clients; and step 9 of charging the viewer clients for the knowledge point, and providing the knowledge information to the viewer clients.

Preferably, the step 1 includes step 1-1 of receiving, from the questioner client, information indicating whether the input question information is a secret question, to which the registered answer information is not generated as the knowledge information and is provided only to the questioner client, and step 1-2 of, if the input question information is a secret question, resetting the provided points by adding a predetermined percentage of the provided points, input by the questioner client, to the provided points; and the step 4 includes step 4-1 of, if the registered question information is a secret question, comparing an ID for the registration of the question information and an ID of the questioner client.

Preferably, the step 3 includes step 3-1 of receiving, from the answerer client, information indicating whether the input answer information is a secret answer that is excluded from the knowledge information and is provided only to the questioner client, and information about additional points that are requested to be additionally provided when the questioner client selects the answer information selected as a secret answer; the step 4 includes step 4-2 of providing the questioner client with the information about whether the answer information is a secret answer and the information about the additional points for the secret answer; and the step 6 includes step 6-1 of, if the questioner client selects the answer information selected as a secret answer at the step 5, providing the answerer client with the additional points in return for the secret answer along with the knowledge points.

Preferably, the step 3 includes step 3-2 of receiving, from the answerer client, information about a lower limit number of the knowledge points that will be provided when the questioner client selects the input answer information; and the step 6 includes step 6-2 of comparing the number of the knowledge points with the lower limit number, step 6-3 of providing the knowledge points to the answerer client when the number of the knowledge points is equal to or greater than the lower limit number, step 6-4 of providing a lower limit number error message to the questioner client when the number of the knowledge points is less than the lower limit number, and step 6-5 of receiving, from the questioner client, information about either one of the provision of the number of the knowledge points equal to or greater than the lower limit number and cancellation of the selection of the answer information, wherein the step 6-3 is selectively performed with the step 6-4 and the step 6-5.

Preferably, the step 7 includes step 7-1 of setting an evaluation period, during which knowledge evaluation of the generated knowledge information will be performed, and setting a number of evaluators, which is a number of viewer clients that will perform the knowledge evaluation; and the step 9 includes step 9-1 of, if the selected knowledge information is in the process of knowledge evaluation during the evaluation period and a number of viewer clients participating in the knowledge evaluation is less than the number of the evaluators, receiving information about whether the viewer clients will participate in the knowledge evaluation from the viewer clients, step 9-2 of, if the viewer clients select participation in the knowledge evaluation, receiving, from the viewer clients, evaluation content for each piece of answer information of the selected knowledge information, step 9-3 of receiving new knowledge points within a specific range of the knowledge points from the viewer client, step 9-4 of including the input evaluation content in the knowledge information, step 9-5 of resetting the knowledge points to an average of the knowledge points and the new knowledge points, and step 9-6 of refunding the knowledge points charged to the viewer client, wherein the step 9-2 and the step 9-3 are performed in any sequence, and the step 9-4 and the step 9-5 are performed in any sequence.

Additionally, the present invention provides a knowledge trading system for intermediating knowledge trading between questioner clients for registering question information, answerer clients for registering general answer information for the question information, and advertiser clients for registering advertising answer information for the question information, registering traded knowledge, and providing knowledge information, to viewer clients for searching and viewing knowledge, the knowledge trading system including a knowledge processing unit, including a question processing module for receiving and registering question information, including question content and provided points, to be provided to one or more answerer clients that input selected answers, from each of the questioner clients, and providing the question information to each of the answerer clients and each of the advertiser clients, an answer processing module for receiving and registering general answer information, including answer content and additional points, additionally requested to be provided along with the provided points when the general answer information is selected, from one or more of the answerer clients, receiving and registering advertising answer information, including answer content, advertising information and advertising points, to be provided to the questioner client when the advertising answer information is selected, from one or more of the advertiser clients, and providing the general answer information and the advertising answer information to the questioner client, and a point provision module for providing the sum of the provided points and the additional points to an answerer client that has provided general answer information selected by a questioner client, from each piece of the general answer information, as knowledge points, and providing the questioner client with the advertising points of advertising answer information selected by the questioner client; a knowledge registration unit for generating the knowledge information by combining the question information, the selected general answer information and the advertising answer information, and registering the generated knowledge information; a knowledge provision unit for providing the knowledge information to one or more of the viewer clients; and a knowledge database for storing the question information, the general answer information, the advertising answer information and the knowledge information.

Preferably, when the questioner client selects both the general answer information and the advertising answer information, the point provision module provides the answerer client with the knowledge points as the advertising points to be provided to the questioner client. The advertising information includes advertising messages, advertising images and links to the websites of the advertisers.

Preferably, the knowledge provision unit charges the knowledge points to a viewer client that requests knowledge information including the general answer information, and provides advertising points to a viewer client that requests knowledge information including the advertising answer information.

Additionally, the present invention provides a knowledge auction method of intermediating knowledge trading between questioner clients for registering question information, answerer clients for registering general answer information for the question information, and advertiser clients for registering advertising answer information for the question information, registering traded knowledge, and providing knowledge information to viewer clients for searching and viewing knowledge, the knowledge auction method including step 1 of receiving question information, including question content and provided points, to be provided to one or more answerer clients that input selected answers, from each of the questioner clients; step 2 of storing the question information, and providing the question information to each of the answerer clients and each of the advertiser clients; step 3 of receiving general answer information, including answer content and additional points, additionally requested to be provided along with the provided points when the general answer information is selected, from one or more of the answerer clients; step 4 of, from one or more of the advertiser clients, receiving advertising answer information, including answer content, advertising information and advertising points, to be provided to the questioner client when the advertising answer information is selected; step 5 of storing the general answer information and the advertising answer information, and providing part of the answer content, the additional points and the advertising points; step 6 of allowing the questioner client to select one or more pieces of answer information from the general answer information and/or the advertising answer information; step 7 of, if the questioner client selects the general answer information, providing the sum of the provided points and the additional points to one or more answerer clients that input the selected general answer information, as knowledge points; step 8 of, if the questioner client selects the advertising answer information, providing the advertising points for the selected advertising answer information to the questioner client; step 9 of generating knowledge information by combining the question information and the selected answer information, and storing the generated knowledge information; and step 10 of receiving a request for provision of the knowledge information from one or more viewer clients, and providing the requested knowledge information to the one or more viewer clients.

Preferably, the step 10 includes step 10-1 of, if a viewer client requests knowledge information including general answer information, charging this viewer client for knowledge points; and step 10-2 of, if a viewer client requests knowledge information including advertising answer information, providing this viewer client with the advertising points.

### ADVANTAGEOUS EFFECTS

According to the knowledge auction system and method according to the present invention, knowledge trading through questions and answers between the questioner clients and the answerer clients is performed through auctions, so that the price for knowledge can be reasonably determined depending on the uniqueness, difficulty and quality of knowledge, with the result that knowledge trading can be promoted, and the uniqueness and quality of provided knowledge can be significantly improved.

Furthermore, each advertiser client can register an answer including advertising information while presenting advertising points, and can provide viewer clients with advertising information along with knowledge information, so that an advertising effect can be achieved. Furthermore, an indication that knowledge information includes an advertising answer is provided before a viewer client selects the knowledge information, and the viewer client is encouraged to access the website of an advertiser by providing advertising points if the viewer client selects the knowledge information, so that the rate of access to the website of the advertiser can be increased without causing antipathy of the viewer client towards the advertisement, with the result that an advertising effect can be significantly improved.

Furthermore, an answerer client is allowed to input the lower limit number of knowledge points, so that knowledge information can be prevented from being traded for an excessively small number of knowledge points, with the result that the registration of answers by the answerer clients can be promoted.

Furthermore, the knowledge evaluation of registered knowledge information is performed by a predetermined number of viewer clients during a predetermined evaluation period, so that knowledge points can be appropriately reset, with the result that the trading price of the knowledge information can be reasonably and objectively set.

Furthermore, the range of new knowledge points input by viewer clients that participate in knowledge evaluation is limited, and knowledge points are reset to the average of the input new knowledge points and existing knowledge points, so that the knowledge points can be prevented from being set to an excessively large or small value. Furthermore, the evaluation content of viewer clients that participate in knowledge evaluation is provided along with knowledge information, so that other viewer clients can be provided with more objective knowledge information.

### BRIEF DESCRIPTION OF THE DRAWINGS

FIG. 1 is a diagram showing the construction of a knowledge auction system according to an embodiment of the present invention;

FIGS. 2 and 3 are flowcharts showing a knowledge auction process according to the present invention;

FIG. 4 is a diagram showing the construction of a knowledge auction system according to another embodiment of the present invention;

FIG. 5 is a view showing the knowledge information providing page of the knowledge auction system according to another embodiment of the present invention;

FIG. 6 is a flowchart showing a knowledge auction process according to another embodiment of the present invention; and

FIG. 7 is a flowchart showing a knowledge evaluation process according to the present invention.

### MODE FOR THE INVENTION

The present invention will be described in detail through preferred embodiments with reference to the accompanying drawings below.

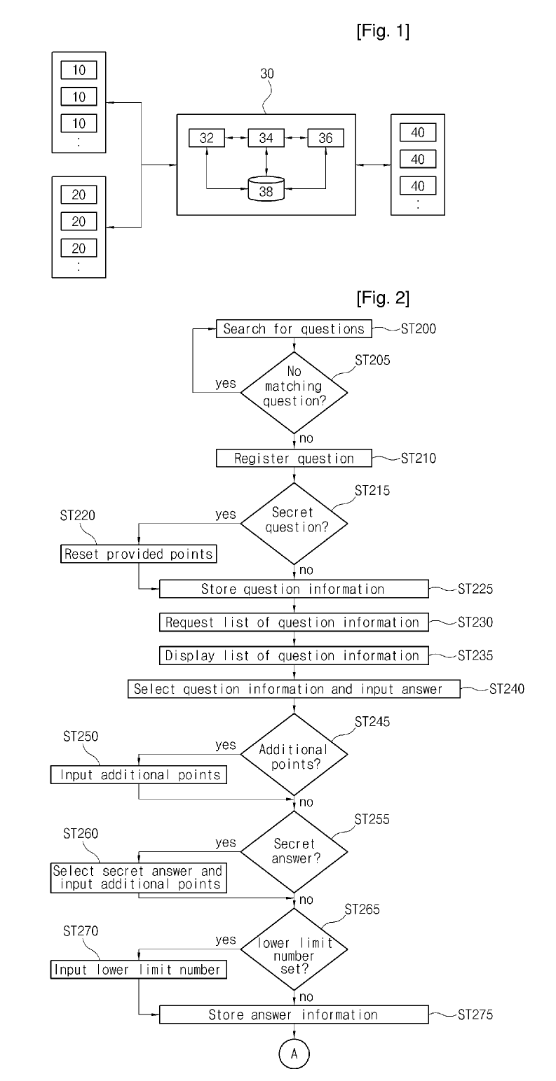

FIG. 1 is a diagram showing the construction of a knowledge auction system according to an embodiment of the present invention. The knowledge auction system according to the present embodiment, as shown in FIG. 1, includes a plurality of questioner clients 10 for registering questions, a plurality of answerer clients 20 for registering answers to the questions from the questioner clients, a knowledge trading system 30 for registering knowledge and providing registered knowledge while working in conjunction with the questioner clients and the answerer clients, and a plurality of viewer clients 40 for viewing knowledge provided by the knowledge trading system.

The questioner clients 10, the answerer clients 20 and the viewer clients 40 access the website of the knowledge trading system 30 through the Internet or a wired/wireless communication network. For this purpose, each of the questioner clients, the answerer clients and the viewer clients is equipped with a terminal that can access the Internet or a wired/wireless communication network. Such a terminal includes a PC, a notebook computer, a PDA, a mobile phone or the like.

The respective elements will be described in detail below.

Each of the questioner clients 10 accesses the knowledge trading system 30, registers a question with the knowledge trading system 30, and inputs points to be provided in return for answers. The points are property that can be circulated, such as cyber money or real money. The questioner client may input only a question without inputting points to be provided. The questioner client may also input an answer period, that is, a time period within which answers to a question can be registered. The questioner client 10 checks summaries of answers registered by respective answerer clients 20, determines whether there are additionally requested points, selects a desired answer, and then provides points. The provided points may be points that have been previously paid to the knowledge trading system 30 by the questioner client 10 and are held by the questioner client 10, or that have been charged by the knowledge trading system at the time of providing the points, and have been paid for by the questioner client 10. Meanwhile, the questioner client 10 may select a plurality of answers, in which case the questioner client 10 may determine the ratios between answers depending on the quality of answers, and may provide points based on the determined ratios. If the questioner client 10 does not select any answer, basic points set by the knowledge trading system 30 are provided equally to the respective answerer clients 20. Meanwhile, in the present specification, points that are registered to be provided in return for an answer when the questioner client registers a question are referred to as “provided points”, points that are additionally requested by an answerer client 20, in addition to the provided points, while the answerer client registers an answer are referred to as “additional points”, and points that are actually provided to the answerer client by the questioner client when an answer is selected are referred to as “knowledge points”.

Each of the answerer clients 20 accesses the knowledge trading system 30, checks registered questions and provided points, and registers one or more answers thereto. In this case, the answerer client 20 may select provided points, presented by the questioner client 10, without change, or may present additional points in addition to the provided points. That is, the answerer client may present more additional points depending on the quality and uniqueness of answers. Meanwhile, in the case where the questioner client 10 registers only a question without inputting the provided points, the answerer client 20 inputs additional points when an answer is registered. In the case where the answerer client 20 does not input additional points, knowledge points, which are provided when an input answer is selected, are set at zero points, or basic points set in the knowledge trading system 30. The answerer client 20 is provided with knowledge points when the answer thereof is selected by the questioner client 10. The knowledge points are the provided points when an answerer client does not input additional points. The knowledge points are the sum of provided points and additional points when the answerer client inputs the additional points.

The knowledge trading system 30 intermediates knowledge trading between the questioner clients 10 and the answerer clients 20, registers the traded knowledge, and provides the viewer clients 40 with the registered knowledge. The knowledge trading system 30 includes a knowledge processing unit 32 for registering the questions of the questioner clients 10 and the answers of the answerer clients 20, a knowledge registration unit 34 for generating knowledge information using answers selected by the questioner clients 10 and registering the knowledge information in a knowledge database 38, a knowledge provision unit 36 for providing the viewer client 40 with knowledge registered in the knowledge database 38, and the knowledge database 38 for classifying and storing information about questions made by the questioner clients 10, and answers registered by the answerer clients 20, and the knowledge information generated by the knowledge registration unit 34.

The knowledge processing unit 32 performs the registration of the questions of the questioner clients 10, the registration of the answers of the answerer clients 20, and the provision of points in return for selected answers. The knowledge processing unit 32 includes a question processing module for storing questions, made by the questioner clients 10, in the knowledge database 38, an answer processing module for storing answers, registered by the answerer client 20, in the knowledge database, and a point provision module for providing the knowledge points to the answerer clients, that is, the providers of answers selected by the questioner clients.

The question processing module classifies information about questions registered by the questioner client 10 and stores the information in the knowledge database 38. At this time, it is preferred that the information about questions be classified into categories according to the type of question, and then be stored in the knowledge database 38. The categories may be selected by the questioner clients 10 at the time of registering questions, or may be selected by the question processing module using the frequencies of words or keywords included in the questions. Each piece of stored question information may include a question identification code for identifying a question, a questioner identification code for identifying a corresponding questioner client, a question category, a question title, question content, provided points, and an answer period. Furthermore, the question processing module provides the registered question information to the answerer clients 20. In greater detail, when an answerer client 20 accesses the knowledge trading system 30 and requests a question list from the knowledge trading system 30 through keyword search or the selection of a category, the question processing module extracts corresponding question information from the knowledge database 38, and displays information, such as a question title, question content, provided points and an answer period.

The answer processing module stores information about answers, registered by the answerer clients 20 within an answer period for each question, in the knowledge database 38. Each piece of stored answer information may include an answer identification code for identifying an answer, a question identification code, an answerer identification code for identifying a corresponding answerer client, answer content, and additional points. In this case, the question identification code is used to identify the question to which a corresponding answer has been made, using the question identification code included in the question information. Furthermore, the answer processing module provides a questioner client 10, which has registered a corresponding question, with registered answer information, that is, information including answer content and additional points.

The point provision module provides one or more corresponding answerer clients 20 with knowledge points when the questioner client 10 selects one or more of several registered answers. When the answerer clients 20 do not input additional points, the provided points are the knowledge points, while, when the answerer client inputs additional points, the sum of the provided points and the additional points is the knowledge points. Furthermore, the knowledge points provided when neither additional points nor provided points are input are zero points, or are basic points set in the knowledge trading system 30. Meanwhile, if a questioner client 10 selects a plurality of answers, the point provision module receives information about the ratios between answers from the questioner client, and provides knowledge points based on the received ratios. In greater detail, the point provision module provides the knowledge points (provided points, or the sum of provided points and additional points), which will be provided in return for each answer, based on the ratio of the answer to the other answers, input by the questioner client. When a questioner client does not input the ratios between answers, an equal ratio is applied to a plurality of selected answers. The point provision module transmits information about points, provided to each answerer client 20, to the knowledge registration unit 34. The point provision information includes a question identification code, the answer identification code of a selected answer, the answerer identification code of a selected answerer client, provided knowledge points, and the ratios between answers in the case where a plurality of answers is selected.

The knowledge registration unit 34 stores answers, selected by the questioner clients 10, in the knowledge database 38. The knowledge registration unit 34 receives point provision information from the point provision module, and generates knowledge information by extracting and combining question information and answer information using a question identification code and an answer identification code included in the point provision information. The knowledge information includes a knowledge identification code, a questioner identification code, an answerer identification code, a category, a question title, question content, answer content and knowledge points. The questioner identification code is the identification code of a questioner client 10 that registered a corresponding question, and the answerer identification code is the identification code of an answerer client 20 that registered a corresponding answer. In this case, if a plurality of answers is selected, the knowledge information includes all of the answerer clients of the selected answers, and further includes the ratios between the answers. The category, the question title and the question content are information included in corresponding question information, and the answer content is also information included in selected answer information. The generated knowledge information is classified and stored in the knowledge database 38.

The knowledge provision unit 36 provides the viewer clients 40 with the knowledge registered with the knowledge database 38. In greater detail, when a viewer client 40 accesses the knowledge trading system 30 and requests knowledge from the knowledge trading system 30 through keyword search or the selection of a category, the knowledge provision unit 36 loads and displays corresponding knowledge information. For example, in the case of a keyword search, when the viewer client 40 inputs a keyword, adequate knowledge information, which is found from the question titles and question content of respective pieces of knowledge information stored in the knowledge database 38, is extracted and displayed. Furthermore, in the case of the selection of a category, knowledge information included in a corresponding category is displayed. The knowledge information is provided in such a way that the answer content of the knowledge information, which has been selected by the viewer client 40, is provided after the question title and the question content have been displayed. The knowledge provision unit 36 may charge each viewer client 40 a fee for the viewing of knowledge information. The charged fee may be the knowledge points of the corresponding knowledge information. In this case, when question titles and question content are displayed such that the viewer client 40 can select knowledge information, the knowledge points of each piece of knowledge information must be displayed also.

The knowledge database 38 classifies and stores question information, that is, information about questions registered by the questioner clients 10, answer information, that is, information about answers registered by the answerer clients 20, and knowledge information generated by the knowledge registration unit 34. Meanwhile, the knowledge database 38 may store provided point information, which is generated by the point provision module and transmitted to the knowledge registration unit 34. Each piece of point provision information includes a question identification code, an answer identification code, an answerer identification code, knowledge points, and ratios between answers.

Each of the viewer clients 40 accesses the knowledge trading system 30, and searches for knowledge information through keyword search or the selection of a category. The viewer client 40 selects desired knowledge information based on the question titles and question content of the found knowledge information, pays knowledge points for the selected knowledge information, and is then provided with answer content.

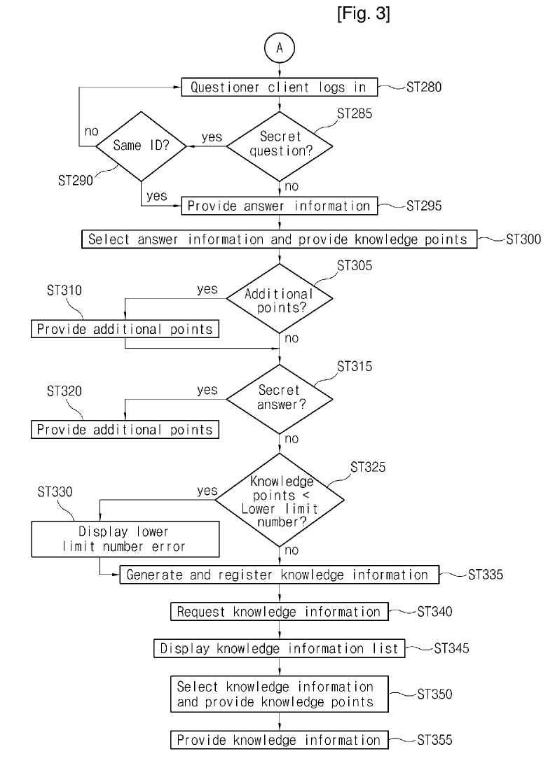

A knowledge auction process according to the present invention is described below with reference to FIGS. 2 and 3.

A questioner client 10 accesses and logs in to the knowledge trading system 30, and searches for the same or similar question before registering a question at step ST200. At this time, the question search may use keyword search or knowledge search through the selection of a category, which is provided by the knowledge provision unit 36.

If the same or a similar question does not exist at step ST200, the questioner client 10 registers a question at steps ST205 and ST210. In particular, the questioner client 10 inputs a question title, question content, provided points and an answer period.

Furthermore, the questioner client 10 determines whether to register the registered question as a secret question at step ST215. The secret question is a question for which the answer information is provided only to the questioner client 10. The question information, registered as a secret question, and answer information, provided for the question information, are not generated as knowledge information by the knowledge registration unit 34. Accordingly, in the case of the secret question, provided points are set to a specific number of points or more.

If the questioner client 10 chooses to make the registered question a secret question at step S215, the question processing module resets the provided points, input by the questioner client, to a specific number of points or more at step ST220. In other words, if the provided points input by the questioner client 10 are less than the specific number of points necessary for the secret question, the question processing module provides notification of a minimum number of provided points necessary for the registration of the secret question, and requests the number of points to be provided to be input again. In this case, the minimum number of points provided for the secret question may be set as a number of points obtained by adding a weight corresponding to a certain percentage to the basic points set in the knowledge trading system 30. For example, when the basic number of points of the knowledge trading system 30 is 100 points, the basic number of points may be set to 150 points, which is obtained by adding 50% of the 100 points to the former basic number of points, for the secret question.

The question processing module stores question information in the knowledge database 38 at step ST225. That is, the question processing module generates a question identification code, and stores the generated question identification code in the knowledge database 38 along with an input question title, question content, provided points and an answer period. In this case, the category of the question information may be directly selected by the questioner client, or may be stored together with the question information after the question processing module has set using the input question title and the question content. Preferably, the question information further includes a value indicating whether the question is a secret question.

When an answerer client 20 accesses the knowledge trading system 30 and requests a question information list, the question processing module loads and displays the question information stored in the knowledge database 38 at steps ST230 and ST235.

The answerer client 20 searches for question information by inputting a keyword, or requests question information by selecting the category of the question information. In the case of the keyword search, the question processing module searches the question titles and question content of respective pieces of the question information, stored in the knowledge database, using a keyword input by the answerer client, and extracts corresponding question information. In the case of the selection of a category, the question processing module extracts question information having a category value identical to the value of the selected category from the knowledge database. The question processing module extracts question information having valid answer periods from the found question information, and provides the answerer client with a list of question titles, question content, provided points and answer periods.

The answerer client 20 selects question information that it will answer, from the question information list, and inputs answer content at step ST240. The input of the answer content is performed by uploading a file including the answer content or by entering the answer content in an additional input window.

The answerer client may input additional points if the answerer client wants the additional points for the input answer content at steps ST245 and ST250. When the answerer client does not input the additional points, the additional points are set to “0”. Furthermore, in the case where the questioner client 10 does not input the provided points at step ST210, the knowledge points provided when a corresponding answer is selected are set to ‘0’, or the basic points, which have been set in the knowledge trading system 30 as a basis, if the answerer client 20 does not input the additional points.

The answerer client 20 determines whether to register the input answer content as a secret answer at step ST255. If the input answer content is registered as a secret answer, the answerer client 20 inputs additional points to be additionally paid at step ST260. In the case of the secret answer, only the questioner client 10, which has registered corresponding question information, can view the secret answer, and the answer information, registered as the secret answer, is not registered as knowledge information by the knowledge registration unit 34. In other words, only the corresponding questioner client 10 can view the answer content after paying the provided points and the additional points.

Furthermore, the answerer client 20 inputs a lower limit number when it wants to set the lower limit number of the knowledge points that will be provided when registered answer information is selected at steps ST265 and ST270. The lower limit number of the knowledge points is the lower limit number of knowledge points that should be paid for corresponding answer information regardless of the number of pieces of selected answer information when the questioner client 10 selects answer information. Accordingly, even when the questioner client 10 selects multiple pieces of answer information and the knowledge points are paid for each piece of answer information according to a specific ratio, answer information can be selected only when a lower limit number of knowledge points are paid for answer information for which the lower limit number is set.

The answer processing module generates an answer identification code, and then stores a question identification code, an answerer identification code, input answer content and additional points in the knowledge database 38 at step ST275. Preferably, the stored answer information further includes a value indicating the lower limit number of the knowledge points and whether it is a secret answer.

When the questioner client 10 logs in to the knowledge trading system 30, selects question information that it has registered, and requests registered answer information, the answer processing module determines whether the selected question information is a secret question at steps ST280 and ST285. If the selected question information is a secret question, the answer processing module examines the ID of the questioner client that is logging in, and examines the ID of the questioner client that has registered the selected question information again. If the IDs are the same, the answer processing module provides the registered answer information at steps ST290 and ST295. Furthermore, if the selected question information is not the secret question, the answer processing module provides the registered answer information. In this case, the provided answer information includes the answer content and additional points of the answer information registered for the selected question information. Meanwhile, the answer processing module may provide the questioner client with the answer content and additional points of the answer information registered in an answer period after the elapse of the answer period set by the questioner client 10. At this time, it is preferable to provide a summary or part of the full text of the answer content, input by the answerer client 20, as the provided answer content. For example, only the first five lines of answer content, or 10% or less of the total answer content, may be provided.

The questioner client 10 selects a desired one from among registered answers, and the point provision module provides knowledge points to the answerer client 20 of the selected answer at step ST300. At this time, if the selected answer is an answer related to additional points, the point provision module informs the questioner client of this fact. If the questioner client has selected the provision of the additional points, the point provision module provides points, which are obtained by adding the additional points to the provided points, to the answerer client as knowledge points at steps ST305 and ST310. In the case where the questioner client has rejected the provision of the additional points, a corresponding answer cannot be selected. In the case where the selected answer is an answer not including additional points, the provided points are provided as the knowledge points. Furthermore, in the case where neither the provided points nor the additional points are input, knowledge points are ‘0’, or are basic points. In the case where the questioner client 10 has points for which money has been previously paid to the knowledge trading system 30, the point provision module deducts the knowledge points from the possessed points. In the case where points for which money has been previously paid by the questioner client 10 do not exit or are insufficient, the questioner client is charged for the knowledge points and pays for them. Furthermore, in the case where the questioner client 10 has selected a plurality of answers, the questioner client inputs a percentage of knowledge points for each answer, and the point provision module provides the points according to the input percentage. For example, if the questioner client has set a percentage of 60% for an answerer client A and a percentage of 40% for an answerer client B, the client A is provided with knowledge points corresponding to 60,000 Won, and the client B is provided with knowledge points corresponding to 40,000 Won when the provided points correspond to 100,000 Won and neither of the clients A and B has input additional points. If the client A has input 100,000 Won as additional points and the client B has input 50,000 Won as additional points, the client A may be provided with 120,000 Won, that is, 60% of 200,000 Won (that is, the sum of the provided points and the additional points), and the client B may be provided with 60,000 Won, that is, 40% of 150,000 Won. In the case where the client A has not input additional points and the client B has input 50,000 Won as additional points, the client A may be provided with 60,000 Won, that is, 60% of 100,000 Won (that is, provided points), and the client B may be provided with 60,000 Won, that is, 40% of the sum of the provided points and the additional points. In the case where the questioner client has not input the ratios between respective answers, an equal ratio may be applied to the selected answers.

Furthermore, if there is a secret answer among the answers selected by the questioner client 10, the point provision module provides additional points requested by a corresponding answerer client 20 at steps ST315 and ST320. As described above, the answer information, registered as the secret answer, is provided only to the questioner client 10, and is not included in knowledge information by the knowledge registration unit 34.

Meanwhile, in the case where the lower limit number of knowledge points is set for an answer selected by the questioner client 10, that is, in the case where the lower limit number of the knowledge points is included in corresponding answer information, the point provision module compares the number of knowledge points, calculated for a corresponding answer, and the lower limit number. If, as a result of the comparison, the number of the calculated knowledge points is less than the lower limit number, the point provision module displays a lower limit number error message on the questioner client 10 at steps ST325 and ST330. The questioner client may select the provision of knowledge points equal to or greater than the lower limit number to a corresponding answer, or may cancel the selection of a corresponding answer. Meanwhile, in the case where the questioner client 10 has not selected a registered answer, each answerer client 20 is provided with basic points. In the above example, in the case where seven answerer clients have registered answers, each of the answerer clients can be provided with 10,000 Won, that is, 10% of the provided points, as basic points. Furthermore, in order to prevent the questioner client from selecting an answer without permission, in the case where the questioner client does not accept a specific number of answers a number of times equal to or greater than a predetermined number, a sanction, such as the sending of a warning message to the questioner client or the deprivation of the membership of the questioner client, may be imposed. The provided knowledge points may be exchanged with cash or some other property and provided according to the selection of the answerer client 20.

The point provision module sends the point provision information to the knowledge registration unit 34, and the knowledge registration unit 14 generates knowledge information and stores it in the knowledge database 38 at step ST335. Each piece of point provision information includes information, such as a question identification code, an answer identification code, an answerer identification code, knowledge points, and the ratios between answers. The knowledge registration unit 34 generates knowledge information by extracting and combining the question information and the answer information using the point provision information. Each piece of knowledge information includes information, such as a knowledge identification code, a questioner identification code, an answerer identification code, a category, a question title, question content, answer content, knowledge points and the ratio of provision for each answer.

The viewer client 40 accesses the knowledge trading system 30, and requests knowledge information from the knowledge trading system 30 through keyword search or the selection of a category at step ST340.

The knowledge provision unit 36 searches for and extracts requested knowledge information, and provides a list thereof at step ST345. The knowledge provision unit 36 extracts knowledge information by searching the question titles and question content of knowledge information for a keyword input by the viewer client 40 in the case of keyword search, and extracts knowledge information included in a corresponding category in the case of category selection. At this time, the provided knowledge information list includes question titles, question content and knowledge points.

The viewer client 40 selects knowledge information, which will be viewed, from the knowledge information list, and pays for the knowledge points at step ST350. The knowledge provision unit 36 extracts the answer content of the selected knowledge information from the knowledge database 38, and displays the extracted answer content at step ST355. In the case where the selected knowledge information is knowledge information related to a plurality of selected answers, the ratios between respective answers are displayed together with the answer content. Accordingly, the viewer client 40 can determine which answer is more suitable for a question.

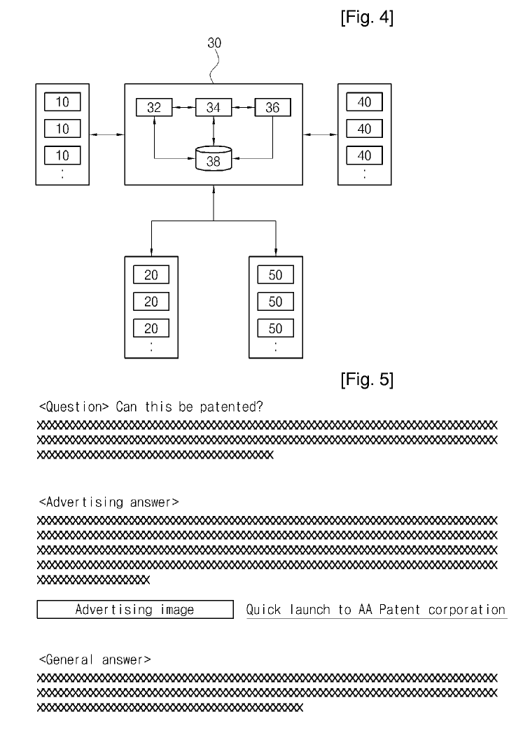

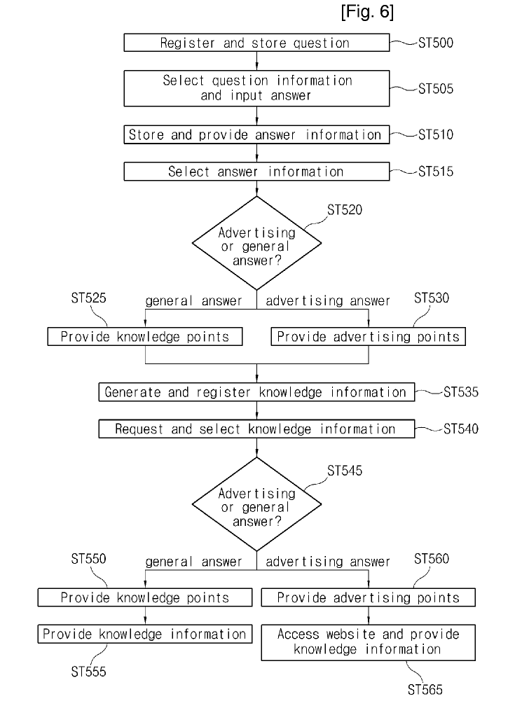

FIG. 4 is a diagram showing the construction of a knowledge auction system according to another embodiment of the present invention. FIG. 5 is a view showing the knowledge information providing page of the knowledge auction system according to another embodiment of the present invention. The present embodiment includes a plurality of questioner clients 10 for registering questions, a plurality of answerer clients 20 for registering general answers to the questions of the questioner clients, a plurality of advertiser clients 50 for registering advertising answers to the questions of the questioner clients, a knowledge trading system 30 for intermediating knowledge trading between the questioner clients, the answerer clients and the advertiser clients, and providing registered knowledge, and a plurality of viewer clients 40 for viewing the knowledge provided by the knowledge trading system. In the present embodiment, the answerer clients 20 and the advertiser clients 50 register answers to questions registered by the questioner clients 10. The advertiser clients 50 perform Internet advertisement while making answers to the questions registered by the questioner clients 10. Hereinafter, an answer registered by an advertiser client is referred to as an “advertising answer,” and an answer registered by the answerer client is referred to as a “general answer” so as to distinguish it from the “advertising answer.” Since the general answer of the present embodiment is similar to the answer of the above-described embodiment, a description is given with emphasis on the advertising answer.

The advertiser clients 50 access the knowledge trading system 30, check registered questions, and register advertising answers, like the answerer clients 20. In this case, the advertiser clients input advertising points, instead of additional points, while registering the advertising answers. The advertising points are points that are provided to the questioner clients 10 in return for corresponding advertising answers selected by the questioner client 10, unlike the additional points. The advertising points are a kind of advertising expense. The advertiser clients 50 input advertising information, including advertising messages, advertising images or links to websites, which, along with answer content, will be provided to the viewer clients 40 when advertising answers are selected along with the answer content. Accordingly, the information of the advertising answers (advertising answer information), which is stored in the knowledge database 38, includes the advertising points and the advertising information instead of additional points, and the knowledge information further includes the advertising information.

When a questioner client 10 selects an advertising answer, advertising points input by a corresponding advertiser client 50 are provided to the questioner client. Furthermore, the questioner client may provide the answerer client 20 with advertising points provided thereto as knowledge points when selecting both an advertising answer and a general answer. In this case, a specific percentage of the advertising points may be provided to the knowledge trading system 30.

Selected advertising answers constitute knowledge information in the same manner as general answers, and thus can be searched for and viewed by the viewer client 40. When viewer clients select knowledge information including advertising answers, the knowledge provision unit 36 indicates that the knowledge information includes advertising answers. When the viewer clients select viewing, the knowledge provision unit 36 provides the viewer clients with the advertising answers. For the knowledge information provided at this time, advertising information input by the advertiser clients 50 is displayed along with answer content, as shown in FIG. 5. In particular, in the case where the advertising information is links to websites, the viewer clients access corresponding websites. Furthermore, the viewer clients 40 may be provided with a specific percentage of the advertising points instead of the knowledge points.

Meanwhile, the knowledge provision unit 36 may place knowledge information having greater advertising points at a higher location when a viewer client 40 performs a knowledge search, and may also place an advertising answer at a location higher than that of a general answer when both the general answer and the advertising answer are selected as knowledge information.

FIG. 6 is a flowchart showing a knowledge auction process according to another embodiment of the present invention. The embodiment of the knowledge auction process according to the present invention is described with reference to FIG. 6 below.

A questioner client 10 accesses the knowledge trading system 30 and registers a question. The question processing module stores question information in the knowledge database 38 at step ST500. At this time, whether the question will be registered as a secret question may be selected.

An answerer client 20 or an advertiser client 50 accesses the knowledge trading system 30, selects the question information, and inputs answer content at step ST505. At this time, the answer processing module receives information about additional points, whether the answer is a secret answer, and the lower limit number from the answerer client 20 if the input answer content is a general answer, and receives information about advertising points and advertising information from the advertiser client 50 if the answer is an advertising answer. The advertising information includes an advertising message, an advertising image, a link to a website or the like, which is desired to be provided to the viewer clients 40 after the advertising answer of the advertiser client 50 has been selected. The general answer and the advertising answer may be identified when the answerer client 20 or the advertiser client 50 inputs an answer, or the answer processing module may identify the answerer client and the advertiser client, so that an answer input by the answerer client is classified as a general answer and an answer input by the advertiser client is classified as an advertising answer.

The answer processing module stores the answer information in the knowledge database 38, and provides it to the questioner client 10 at step ST510. At this time, if the input answer is a general answer, then an answer identification code, a question identification code, an answerer identification code, answer content, additional points, information about whether the answer is a secret answer, and a lower limit number are stored as the answer information. If the input answer is an advertising answer, an answer identification code, a question identification code, an answerer identification code, answer content, advertising points and advertising information are stored as the answer information. Furthermore, in the provision of the answer information to the questioner client 10, part of the answer content and the additional points are provided in the case of a general answer, and part of the answer content and the advertising points are provided in the case of an advertising answer.

The questioner client 10 selects a desired one from among registered answers at step ST515.

If the questioner client has selected a general answer at step ST515, the point provision module provides knowledge points to the answerer client 20 of the selected answer at steps ST520 and ST525. In contrast, if the questioner client has selected an advertising answer at step ST515, the point provision module provides the questioner client with the advertising points at steps ST520 and ST530. Furthermore, if the questioner client has selected a plurality of answers and has selected both the advertising answer and the general answer at step ST515, the point provision module provides the advertising points, to be provided to the questioner client, to the answerer client as the knowledge points. At this time, the remaining advertising points are provided to the questioner client if the advertising points remain, and the questioner client is charged if there are not sufficient advertising points.

The point provision module transmits the point provision information to the knowledge registration unit 34. The knowledge registration unit 34 generates knowledge information, and stores it in the knowledge database 38 at step ST535. The generated knowledge information includes a knowledge identification code, a questioner identification code, an answerer identification code, a category, a question title, question content, answer content, knowledge points, the ratios between answers and so on when the selected answer is one or more general answers, and includes a knowledge identification code, a questioner identification code, an answerer identification code, a category, a question title, question content, answer content, advertising information, advertising points, the ratios between answers and so on when a selected answer is one or more advertising answers. Furthermore, when both the advertising answer and the general answer are selected, the knowledge information includes both the advertising points and the knowledge points.

A viewer client 40 accesses the knowledge trading system 30, requests knowledge information from the knowledge trading system 30, and selects knowledge information to be viewed at step ST540.

If answer content included in the knowledge information selected at step ST540 corresponds to a general answer, the knowledge provision unit 36 provides the knowledge information to the viewer client 40 after knowledge points have been charged and paid for at steps ST545 to ST555.

In contrast, if the answer content included in the knowledge information selected in ST540 corresponds to an advertising answer, the knowledge provision unit 36 displays the answer content to the viewer client 40, and the knowledge provision unit 36 provides the advertising points if the viewer client selects viewing at steps ST545 and ST560. The knowledge provision unit 36 provides the knowledge information, and connects the viewer client 40 to a linked website at step ST565.

If the answer content included in the selected knowledge information includes both a general answer and an advertising answer, the knowledge provision unit 36 calculates knowledge points to be charged or advertising points to be provided, charges or provides the points, and then provides the knowledge information.

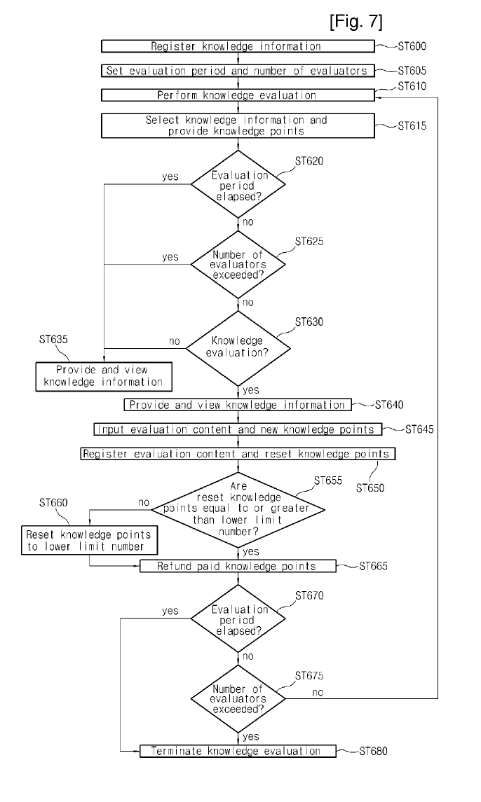

Meanwhile, in the case where the knowledge points of the knowledge information to be provided to the viewer client 40 are determined based only on the provided points input by the questioner client 10 and the additional points input by the answerer client 20, it is difficult to determine a reasonable number of knowledge points. Furthermore, since answer information is selected subjectively by the questioner client 10, it may be difficult to provide high-quality knowledge. Accordingly, the knowledge auction system according to the present invention allows the viewer client 40 to evaluate registered knowledge information. For this purpose, the knowledge trading system 30 further includes a knowledge evaluation unit (not shown) for performing the evaluation of knowledge information, that is, knowledge evaluation. This knowledge evaluation process is shown in FIG. 7.

FIG. 7 is a flowchart showing a knowledge evaluation process according to the present invention. The knowledge evaluation process according to the present invention is described below with reference to FIG. 7.

When the knowledge registration unit 34 generates and registers knowledge information, the knowledge evaluation unit sets a period (an evaluation period) during which knowledge evaluation will be performed and the number of viewer clients 40 that will perform knowledge evaluation (the number of evaluators) at steps ST600 to ST610.

If a viewer client 40 accesses the knowledge trading system 30, selects knowledge information and pays for the knowledge points that are necessary for viewing, the knowledge evaluation unit determines whether the selected knowledge information is in the process of undergoing knowledge evaluation at steps ST615 to ST625. That is, the knowledge evaluation unit determines whether the evaluation period for the selected knowledge information has elapsed and the number of evaluators has been exceeded.

If, for the selected knowledge information, the evaluation period for knowledge evaluation has elapsed or a number of viewer clients 40 equal to the set number of evaluators have already participated in knowledge evaluation, the knowledge evaluation unit transmits a message, indicating that the selected information is knowledge information for which knowledge evaluation has been terminated, to the knowledge provision unit 36. The knowledge provision unit provides the selected knowledge information to the viewer client at step ST635.

In contrast, if, for the selected knowledge, the evaluation period for knowledge evaluation has not elapsed and the number of viewer clients 40 that have already participated in knowledge evaluation is less than the set number of evaluators, the knowledge evaluation unit receives information about whether the viewer client will participate in knowledge evaluation at step ST630. If the viewer client has rejected knowledge evaluation at step ST630, the knowledge provision unit 36 provides selected knowledge information to the viewer client at step ST635.

If the viewer client 40 has selected knowledge evaluation at step ST630, the knowledge provision unit 36 provides selected knowledge information to the viewer client. The knowledge evaluation unit receives evaluation content and new knowledge points from the viewer client at steps ST640 and ST645. In this case, the evaluation content is the opinions of the viewer client on respective pieces of answer content that constitute knowledge information. Furthermore, the new knowledge points indicate knowledge points or the percentages of knowledge points for respective pieces of answer content that are input by the viewer client 40 if it is determined that set knowledge points or the ratios between respective pieces of answer content to each other are inappropriate. In this case, in order to prevent each viewer client 40 from inputting an excessively large or small number of knowledge points or excessively large or small ratios, the new knowledge points or ratios are set to values within a specific range of existing registered knowledge points or ratios. For example, when existing registered knowledge points are 1000 points, the new knowledge points can be set to a value within a range of 800 to 1200 points, which is 20% higher and lower.

The knowledge evaluation unit registers evaluation content, registered by the viewer client 40, in selected knowledge information, and resets the knowledge points based on the new knowledge points at step ST650. The registered evaluation content is provided along with the knowledge information in the future. Furthermore, in the resetting of the knowledge points, the knowledge points may be set to the average of the existing knowledge points registered in advance and the new knowledge points input by the viewer client. The knowledge points may be reset to the average of the new knowledge points input by the viewer clients that participate in knowledge evaluation after the knowledge evaluation, and the existing knowledge points registered in advance. In this case, if the viewer clients do not input new knowledge points, it is determined that the existing registered knowledge points are to be selected. For example, assuming that, during an evaluation period, five viewer clients A, B, C, D and E have participated in knowledge evaluation for knowledge information having 1,000 registered knowledge points, and that the viewer clients B, C and D have input 900 points, 1200 points and 1200 points, respectively, the knowledge points are reset to (1000(existing knowledge points)+1000(by A)+900(by B)+1200(by C)+1200(by D)+1000(by E))/6=1050 points. Accordingly, the knowledge points can not only be appropriately adjusted, but also it is possible to prevent some viewer clients from manipulating, that is, raising or lowering, the knowledge points. This can be applied to the re-adjustment of the percentages of the knowledge points for respective answers in the same manner.

If there is an answer for which a lower limit number is set and which belongs to answers constituting the selected knowledge information, the knowledge evaluation unit determines whether the number of the reset knowledge points is equal to or greater than the lower limit number at step ST655. If the number of the reset knowledge points is less than the lower limit number at step ST655, the number of the knowledge points is reset to the lower limit number at step ST660. Therefore, since the number of the knowledge points is set to a value equal to or greater than the lower limit number input by the answerer client 20, the knowledge information can be prevented from being traded at a value corresponding to an excessively small number of knowledge points.

The knowledge evaluation unit refunds the knowledge points, paid by the viewer client 40 at step ST615, at step ST665. The refunded knowledge points are a compensation for the knowledge evaluation of the viewer client 40. Through such compensation, a greater number of viewer clients are encouraged to participate in knowledge evaluation.

The knowledge evaluation unit checks the evaluation period and the number of evaluators, and terminates the knowledge evaluation of knowledge information for which the evaluation period has elapsed and in which a number of viewer clients equal to the number of evaluators has participated at steps ST670 to ST680. The knowledge information, the knowledge evaluation of which has been terminated, is provided to the viewer clients 40 at reset knowledge points. The evaluation content, input by the viewer clients that have participated in the knowledge evaluation, the evaluation period and the number of evaluators are provided along with the knowledge information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A knowledge trading system for intermediating knowledge trading between questioner clients for registering question information and answerer clients for registering answer information for the question information, registering traded knowledge, and providing knowledge information, including the question information and the answer information, to viewer clients for searching and viewing the knowledge, the knowledge trading system comprising:
a knowledge processing unit, comprising:
a question processing module for receiving and registering question information, including question content and provided points, to be provided to one or more answerer clients that input selected answers, from one of the questioner clients, and providing the question information to each of the answerer clients,
an answer processing module for receiving and registering answer information, including answer content and additional points, additionally requested to be provided along with the provided points when the answer information is selected, from one or more of the answerer clients, and providing the answer information to the questioner client, and
a point provision module for providing a sum of the provided points and the additional points to the answerer clients that input the answer information selected by the questioner client, as knowledge points, receiving percentages of knowledge points, to be provided to the respective answer clients that input the selected answer information, from the questioner client when the questioner client selects multiple pieces of answer information, and providing each of the one or more answerer clients with knowledge points based on the input percentages;
a knowledge registration unit for generating knowledge information by combining the question information and the selected answer information, and registering the generated knowledge information;
a knowledge provision unit for charging the knowledge points to each viewer client that requests the knowledge information, and providing the knowledge information to the viewer client; and
a knowledge database for storing the question information, the answer information, and the knowledge information.

2. The knowledge trading system according to claim 1, wherein:
the question information includes a question identification code for identifying the question information, a questioner identification code for identifying the questioner client, a category for indicating a class of the question information, a question title, the question content, the provided points, and an answer period, that is, a period during which the answerer clients can input answer information; and
the answer information includes an answer identification code for identifying the answer information, a question identification code for identifying the question information, an answerer identification code for identifying the answerer client, the answer content, and the additional points.

3. The knowledge trading system according to claim 1, wherein the knowledge information includes a knowledge identification code for identifying the knowledge information, a questioner identification code for identifying the questioner client, an answerer identification code for identifying the answerer client, a category for indicating a class of the question information, a question title, the question content, the answer content, and the knowledge points.

4. The knowledge trading system according to claim 2, wherein:
the question information further includes a value, indicating whether the registered answer information is a secret question, which is not generated as the knowledge information by the knowledge registration unit and is provided only to the questioner client; and
the answer information further includes a value, indicating whether the registered answer information is a secret answer, which is excluded from the knowledge information generated by the knowledge registration unit and is provided only to the questioner client, and a lower limit number of the knowledge points, to be provided when the questioner client selects the answer information.

5. The knowledge trading system according to claim 1, further comprising a knowledge evaluation unit for receiving evaluation content for the answer information of the generated knowledge information and new knowledge points for the generated knowledge information from each viewer client during a set evaluation period, and performing knowledge evaluation, in which the knowledge points are reset for the knowledge information.

6. A knowledge trading system for intermediating knowledge trading between questioner clients for registering question information, answerer clients for registering general answer information for the question information, and advertiser clients for registering advertising answer information for the question information, registering traded knowledge, and providing knowledge information, including the question information and the answer information, to viewer clients for searching and viewing knowledge, the knowledge trading system comprising:
a knowledge processing unit, comprising:
a question processing module for receiving and registering question information, including question content and provided points, to be provided to one or more answerer clients that input selected answers, from each of the questioner clients, and providing the question information to each of the answerer clients and each of the advertiser clients,
an answer processing module for receiving and registering general answer information, including answer content and additional points, additionally requested to be provided along with the provided points when the general answer information is selected, from one or more of the answerer clients, receiving and registering advertising answer information, including answer content and advertising points, to be provided to the questioner client when the advertising answer information is selected, from one or more of the advertiser clients, and providing the general answer information and the advertising answer information to the questioner client, and
a point provision module for providing a sum of the provided points and the additional points to an answerer client that has provided general answer information selected by a questioner client, from each piece of the general answer information, as knowledge points, and providing the questioner client with the advertising points of advertising answer information selected by the questioner client;
a knowledge registration unit for generating the knowledge information by combining the question information, the selected general answer information and the advertising answer information, and registering the generated knowledge information;
a knowledge provision unit for providing the knowledge information to one or more of the viewer clients; and
a knowledge database for storing the question information, the general answer information, the advertising answer information and the knowledge information.

7. The knowledge trading system according to claim 6, wherein, when the questioner client selects both the general answer information and the advertising answer information, the point provision module provides the answerer client with the knowledge points as the advertising points to be provided to the questioner client.

8. The knowledge trading system according to claim 6, wherein the knowledge provision unit charges the knowledge points to a viewer client that requests knowledge information including the general answer information, and provides advertising points to a viewer client that requests knowledge information including the advertising answer information.

9. A knowledge auction method of intermediating knowledge trading between questioner clients for registering question information and answerer clients for registering answer information for the question information, registering traded knowledge, and providing knowledge information, including the question information and the answer information, to viewer clients for searching and viewing the knowledge, the knowledge auction method comprising:
step 1 of receiving question information, including question content and provided points, to be provided to one or more answerer clients that input selected answers, from each of the questioner clients;
step 2 of storing the question information, and providing the question information to each of the answerer clients;
step 3 of receiving answer information, including answer content and additional points, additionally requested to be provided along with the provided points when the answer information is selected, from one or more of the answerer clients;
step 4 of storing the answer information, and providing part of the answer content and information about the additional points to the questioner client;
step 5 of allowing the questioner client to select one or more pieces of the answer information from the answer information;
step 6 of providing a sum of the provided points and the additional points to the answerer clients that input the answer information selected by the questioner client, as knowledge points;
step 7 of generate knowledge information by combining the question information and the selected answer information, and storing the generated knowledge information;
step 8 of receiving a request for provision of the knowledge information from one or more viewer clients; and
step 9 of charging the viewer clients for the knowledge point, and providing the knowledge information to the viewer clients.

10. The knowledge auction method according to claim 9, wherein:
the step 1 comprises:
step 1-1 of receiving, from the questioner client, information indicating whether the input question information is a secret question, to which the registered answer information is not generated as the knowledge information and is provided only to the questioner client, and
step 1-2 of, if the input question information is a secret question, resetting the provided points by adding a predetermined percentage of the provided points, input by the questioner client, to the provided points; and
the step 4 comprises step 4-1 of, if the registered question information is a secret question, comparing an ID for the registration of the question information and an ID of the questioner client.

11. The knowledge auction method according to claim 9, wherein:
the step 3 comprises step 3-1 of receiving, from the answerer client, information indicating whether the input answer information is a secret answer that is excluded from the knowledge information and is provided only to the questioner client, and information about additional points that are requested to be additionally provided when the questioner client selects the answer information selected as a secret answer;
the step 4 comprises step 4-2 of providing the questioner client with the information about whether the answer information is a secret answer and the information about the additional points for the secret answer; and
the step 6 comprises step 6-1 of, if the questioner client selects the answer information selected as a secret answer at the step 5, providing the answerer client with the additional points in return for the secret answer along with the knowledge points.

12. The knowledge auction method according to claim 9, wherein:
the step 3 comprises step 3-2 of receiving, from the answerer client, information about a lower limit number of the knowledge points that will be provided when the questioner client selects the input answer information; and
the step 6 comprises:
step 6-2 of comparing a number of the knowledge points with the lower limit number,
step 6-3 of providing the knowledge points to the answerer client when the number of the knowledge points is equal to or greater than the lower limit number,
step 6-4 of providing a lower limit number error message to the questioner client when the number of the knowledge points is less than the lower limit number, and
step 6-5 of receiving, from the questioner client, information about either one of the provision of the number of the knowledge points equal to or greater than the lower limit number and cancellation of the selection of the answer information, wherein the step 6-3 is selectively performed with the step 6-4 and the step 6-5.

13. The knowledge auction method according to claim 9, wherein:
the step 7 comprises step 7-1 of setting an evaluation period, during which knowledge evaluation of the generated knowledge information will be performed, and setting a number of evaluators, which is a number of viewer clients that will perform the knowledge evaluation; and
the step 9 comprises:
step 9-1 of, if the selected knowledge information is in the process of knowledge evaluation during the evaluation period and a number of viewer clients participating in the knowledge evaluation is less than the number of the evaluators, receiving information about whether the viewer clients will participate in the knowledge evaluation from the viewer clients,
step 9-2 of, if the viewer clients select participation in the knowledge evaluation, receiving, from the viewer clients, evaluation content for each piece of answer information of the selected knowledge information,
step 9-3 of receiving new knowledge points within a specific range of the knowledge points from the viewer client,
step 9-4 of including the input evaluation content in the knowledge information,
step 9-5 of resetting the knowledge points to an average of the knowledge points and the new knowledge points, and
step 9-6 of refunding the knowledge points charged to the viewer client, wherein the step 9-2 and the step 9-3 are performed in any sequence, and the step 9-4 and the step 9-5 are performed in any sequence.

14. A knowledge auction method of intermediating knowledge trading between questioner clients for registering question information, answerer clients for registering general answer information for the question information, and advertiser clients for registering advertising answer information for the question information, registering traded knowledge, and providing knowledge information, including the question information and the answer information, to viewer clients for searching and viewing knowledge, the knowledge auction method comprising:
step 1 of receiving question information, including question content and provided points, to be provided to one or more answerer clients that input selected answers, from each of the questioner clients;
step 2 of storing the question information, and providing the question information to each of the answerer clients and each of the advertiser clients;
step 3 of receiving general answer information, including answer content and additional points, additionally requested to be provided along with the provided points when the general answer information is selected, from one or more of the answerer clients;
step 4 of, from one or more of the advertiser clients, receiving advertising answer information, including answer content, advertising information and advertising points, to be provided to the questioner client when the advertising answer information is selected;
step 5 of storing the general answer information and the advertising answer information, and providing part of the answer content, the additional points and the advertising points to the questioner client;
step 6 of allowing the questioner client to select one or more pieces of answer information from the general answer information and/or the advertising answer information;
step 7 of, if the questioner client selects the general answer information, providing a sum of the provided points and the additional points to one or more answerer clients that input the selected general answer information, as knowledge points;
step 8 of, if the questioner client selects the advertising answer information, providing the advertising points for the selected advertising answer information to the questioner client;
step 9 of generating knowledge information by combining the question information and the selected answer information, and storing the generated knowledge information; and
step 10 of receiving a request of the knowledge information from one or more viewer clients, and providing the requested knowledge information to the one or more viewer clients.

15. The knowledge auction method according to claim 14, wherein the step 10 comprises:
step 10-1 of, if a viewer client requests knowledge information including general answer information, charging this viewer client for knowledge points; and
step 10-2 of, if a viewer client requests knowledge information including advertising answer information, providing this viewer client with the advertising points.
